(19) United States
(12) Patent Application Publication
(10) Pub. No.: US 2006/0027347 A1
(43) Pub. Date: Feb. 9, 2006

(54) Guide rail for a window blind of a sliding roof system

(75) Inventors: Horst Boehm, Frankfurt/Main (DE); Christian Biewer, Altheim (DE); Rainer Grimm, Frankfurt/Main (DE); Thomas Becher, Rodgau (DE)

Correspondence Address: CARLSON, GASKEY & OLDS, P.C., 400 WEST MAPLE ROAD, SUITE 350, BIRMINGHAM, MI, 48009, US

(73) Assignee: ArvinMeritor GmbH

(21) Appl. No.: 11/181,225

(22) Filed: Jul. 13, 2005

(30) Foreign Application Priority Data
Jul. 14, 2004 (DE) 10 2004 033 982.1

(51) Int. Cl. E06B 9/56

(52) U.S. Cl. 160/273.1

(57) ABSTRACT

The invention relates to a guide rail for a window blind of a sliding roof system. The guide rail includes a retaining portion that attaches the guide rail to a vehicle. The guide rail also includes a guide portion that receives the window blind, and a resilient connecting portion which is arranged between the retaining portion and the guide portion.

The application claims priority to German Application No. 10 2004 033 982.1, which was filed on Jul. 14, 2004.

### BACKGROUND OF THE INVENTION

The invention relates to a guide rail for a window blind of a sliding roof system for a motor vehicle.

A window blind of this type may be attached underneath an opening in a vehicle roof in order to cover the opening to a greater or lesser extent at the choice of vehicle occupants. If the opening is to be exposed, the window blind is wound up on a winding shaft. The window blind is uncoiled from the winding shaft to cover the opening. In order to prevent the window blind, when extending underneath the opening in the vehicle roof, from sagging into the vehicle interior space, longitudinal edges of the window blind are received in guide rails so that the window blind can be held taut transverse to a shifting direction of the window blind in the guide rails.

A specified distance between the guide rails has to be maintained within very narrow tolerances. If this distance is smaller than specified, the window blind sags between the two guide rails into the vehicle interior space. This is undesirable for aesthetical reasons. If this distance between the guide rails is larger than specified, the window blind either can not be shifted within the guide rails at all, or can be shifted only after overcoming very high frictional forces. This adversely affects operability and service life.

It is the object of the invention to provide an improved guide rail for a window blind that easily meets tolerance demands during manufacturing and/or assembly of the guide rail.

### SUMMARY OF THE INVENTION

To this purpose, the subject invention provides a guide rail for a window blind of a sliding roof system. The guide rail includes a retaining portion adapted to attach the guide rail to a vehicle. The guide rail also includes a guide portion that receives the window blind, and a resilient connecting portion which is arranged between the retaining portion and the guide portion.

The invention provides for an automatic compensation of tolerances in the form of the resilient connecting portion, which is elastic and springy. This makes it possible to design and arrange two guide rails in such a manner that a distance between two guide portions of the two guide rails under any tolerance situation is larger than actually necessary. Once the window blind is inserted into each guide portion of the two guide rails, the two guide portions will be pulled towards each other. During operation, the resilient connecting portion elastically yields without high frictional forces occurring. It is ensured in any case that the window blind is always held taut.

Preferably provision is made that both the retaining portion and the guide portion are made in one piece with the resilient connecting portion, for instance as an injection-molded part made from plastic. The inherent elasticity of the plastic ensures, in combination with a suitable wall thickness, the required elastic deformability. As an alternative, extruded profiles of plastic or an aluminum alloy can be used.

These and other features of the present invention can be best understood from the following specification and drawings, the following of which is a brief description.

### BRIEF DESCRIPTION OF THE DRAWINGS

FIG. 1 is a perspective view of a vehicle roof comprising a window blind according to the invention;

FIG. 2 is a schematic side view of a window blind according to the invention; and

FIG. 3 schematically shows a section along plane III-III of FIG. 1.

### DETAILED DESCRIPTION OF THE PREFERRED EMBODIMENT

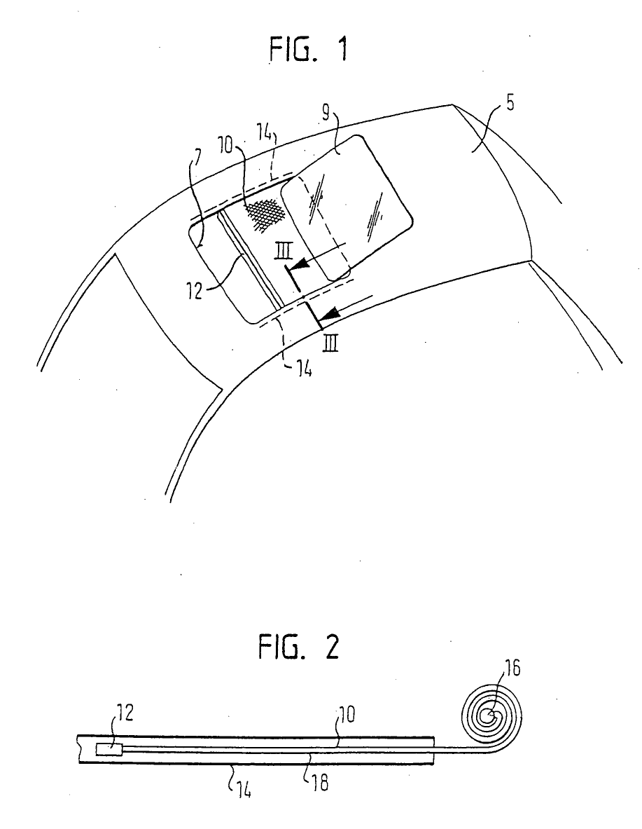

FIG. 1 shows a vehicle including a vehicle roof 5 with an opening 7. Associated with opening 7 is a cover 9 of a sliding roof system. The cover 9 can be shifted between a closed position in which the cover 9 closes the opening 7, and an opened position shown in FIG. 1.

A window blind 10 is arranged underneath the cover 9 and also underneath the opening 7. With regard to the vehicle, the window blind 10 can be moved forwardly and rearwardly by hand or powered by a motor. If the window blind 10 is fully pushed toward the rear of the vehicle, the opening 7 will be entirely exposed. Fresh air and sunlight are able to freely enter a vehicle interior space. If the window blind 10 is fully pushed toward the front of the vehicle, the opening 7 is covered by the window blind 10. Fresh air and sunlight can enter the vehicle interior space only to a limited extent.

The window blind 10 is made from a flexible material, for instance from cloth or a plastic film. Provided on a front edge of the window blind 10 is a hoop 12 that can be gripped by a vehicle occupant in order to displace the window blind 10 to the front or to the rear of the vehicle. Two guide rails 14 are laterally spaced apart from each other and extend longitudinally along sides of the opening 7. Two longitudinal edges of the window blind 10, i.e. right and left edges of the window blind 10 as seen in a longitudinal direction of the vehicle, are received in these guide rails 14. In an area of a rear end of the opening 7 there is disposed a winding shaft 16 (see FIG. 2) on which the window blind 10 can be wound up. The winding shaft 16 is usually biased by a spring, so that the window blind 10 will be automatically received on the winding shaft 16 when the hoop 12 is pushed towards the rear.

Each window blind 10 has a guide element 18 along the longitudinal edges, i.e. in the area associated with the guide rails. The guide element 18 is configured as a thin strip made of metal or plastic.

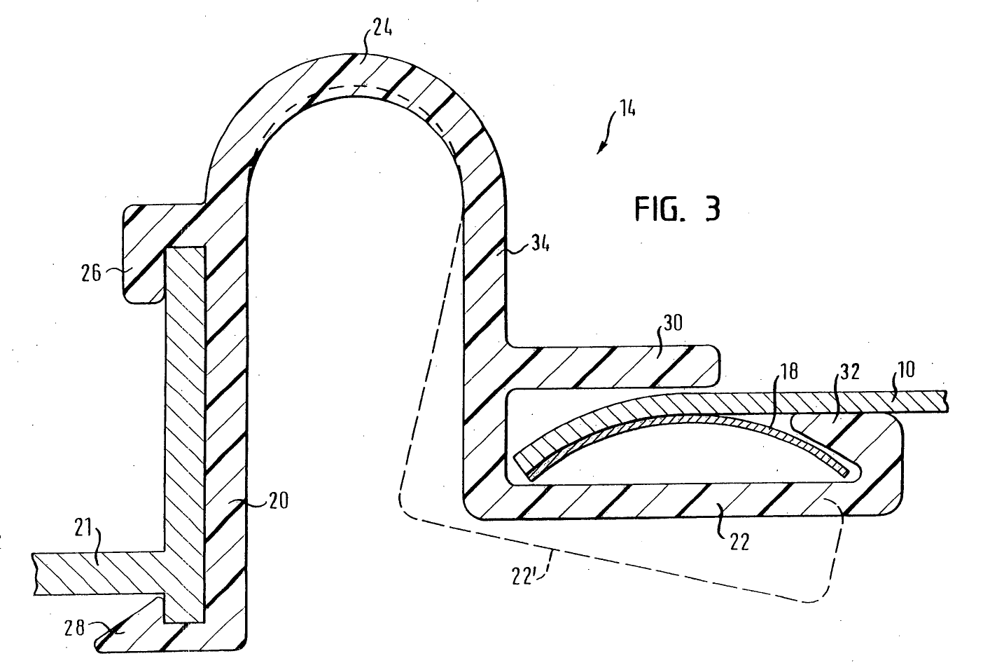

Each guide rail 14 (see in particular FIG. 3) has a retaining portion 20, a guide portion 22 and a connecting portion 24. The retaining portion 20 serves for fastening the guide rail 14 to the vehicle roof 5, for example at an edge portion of a rail 21 for guiding the cover 9. Here, the retaining portion 20 has a retaining ledge 26 and a latching hook 28 that makes it possible to mount the guide rail 14 to the rail 21 that guides the cover 9 with low effort.

The guide portion 22 serves for receiving and guiding the guide element 18 of the window blind 10. To this end, the guide portion 22 is provided with an upper guide web 30 and a guide web 32 directed towards the vehicle interior space.

The connecting portion 24 extends between the retaining portion 20 and the guide portion 22 and is provided here with a semicircular cross-section at an upper end as shown in FIG. 3. The connecting portion 24 is also provided with a connecting web 34 that extends towards the guide portion 22. The connecting portion 24 is configured such that in an initial state the retaining portion 20 and the guide portion 22 have a smaller distance between them (see, in broken line, the position 22′ of the guide portion 22) than in a condition when the window blind 10 is between the two guide rails 14.

If the window blind 10 is withdrawn from the winding shaft 16 and shifted to the front in the guide portions 22, the guide portions 22 will be drawn from their initial position towards each other whereby the window blind 10 is held taut. Due to the elasticity of the connecting portion 24 of the two guide rails 14, the tensional forces exerted on the window blind 10 remain on a relatively low level, so that only low frictional forces occur between the guide elements 18 of the window blind 10 and the guide portions 22 of the guide rails 14. Spring forces exerted by the connecting portions 24 can be adjusted on the one hand by geometry and material. On the other hand, spring forces can be adjusted by suitably selecting a wall thickness to influence spring force, for instance by local thickness reductions at the connecting portion 24 as indicated in broken lines in FIG. 3.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A guide rail for a window blind of a sliding roof system comprising:
a retaining portion adapted to attach a guide rail to a vehicle;
a guide portion that receives a window blind; and
a resilient connecting portion arranged between the retaining portion and the guide portion.

2. The guide rail according to claim 1 wherein the resilient connecting portion and the retaining portion are made as one-piece.

3. The guide rail according to claim 1 wherein the resilient connecting portion and the guide portion are made as one-piece.

4. The guide rail according to claim 1 wherein the resilient connecting portion has a curved cross-section.

5. The guide rail according to claim 1 wherein the resilient connecting portion has a U-shaped cross-section.

6. The guide rail according to claim 1 wherein the guide rail is made from plastic.

7. The guide rail according to claim 1 wherein the guide rail is an extruded profile part.

8. A guide rail assembly comprising:
two guide rails wherein each guide rail includes a retaining portion adapted to attach a guide rail to a vehicle, a guide portion that receives a window blind, and a resilient connecting portion arranged between the retaining portion and the guide portion; and
wherein the guide portions of the two guide rails are arranged to lie opposite each other with the guide portions being spaced apart from each other by a first distance when the window blind is not inserted in the guide portions and being spaced apart from each other by a second distance different from the first distance when the window blind is inserted in the guide portions.

9. The guide rail assembly according to claim 8 wherein the first distance is greater than the second distance.
